(19) United States
(12) Patent Application Publication
(10) Pub. No.: US 2026/0156043 A1
(43) Pub. Date: Jun. 4, 2026

(54) Determining Properties of a Client Communicating Via a Network

(71) Applicant: Deviceatlas Limited, Dublin (IE)

(72) Inventor: Hamish Graham, Dublin (IE)

(21) Appl. No.: 19/122,317

(22) PCT Filed: Oct. 20, 2023
(86) PCT No.: PCT/EP2023/079377

§ 371 Date: Apr. 18, 2025

(30) Foreign Application Priority Data
Oct. 21, 2022 (GB) 2215668.1

(51) Int. Cl. H04L 41/14; G06F 16/901; H04L 41/12

(52) U.S. Cl. CPC H04L 41/14; H04L 41/12; G06F 16/9027

(57) ABSTRACT

Determining properties of a client communicating via a network According to an aspect, there is provided a method of determining properties of a client communicating via a network, the method comprising: receiving an identifier from the client; parsing the identifier into a plurality of tokens; and retrieving in dependence on each token at least one component from a database, the component referencing at least one client property; and determining in dependence on the retrieved components a set of client properties; wherein the database comprises a tree data structure in which previously identified tokens are mapped to corresponding components.

This invention relates to a method of and apparatus for determining properties of a client communicating via a network, such as a communications device. The invention is particularly applicable to enhancing communication with the client/device by taking account of client/device capabilities, such as, for example, facilitating the tailoring and/or optimising of content from a server delivered over a data network to the client/device.

When a client/device communicates over a data network with a server it typically transmits one or more identifiers at one or more times during the communication session, whether at initialisation of the session, periodically during the session and/or when or about to be transmitting or receiving data. The identifier(s) often provide(s) some information about the client/device and/or the software running on the device. For example, when a device requests a web page or other web content from a web server this may involve a browser application running on the device transmitting ‘user agent’ information or responses to ‘Client Hints’ requests or similar identifiers to the web server, the identifier(s) comprising a character string characteristic of the device hardware and software. Parsing such an identifier character string may allow for the client/device properties to be determined, for example from a database comprising a store of previously identified properties of sample clients/devices.

It is known to determine device properties by comparing the user agent string received from the device with known user agent strings stored in a look-up table. In some embodiments this requires a first look-up table to identify the device and a second look-up table to determine the device properties. However, such methods can be slow due to the large size(s) of the look-up table(s) required to account for the large number of user agent strings in common use.

Ideally, the determination needs to be both accurate and fast so that communication with the client/device may proceed appropriately and with minimal delay.

One approach to this problem, also using a store of previously identified device properties of sample communication devices, is described in EP2245836B2, in which the previously identified properties are referenced by sample strings of characters (eg. user agent identifier) associated with the sample communication devices, characterised in that the sample strings of characters are arranged in a tree structured in accordance with the characters of the sample strings of characters, with the nodes of the tree comprising substrings of the sample strings of characters and the previously identified properties being referenced by the nodes of the tree, wherein each previously identified property is referenced by the first node along the tree common to the sample communication devices having that previously identified property.

However, as communications devices have proliferated there has been a concomitant increase in both the number and diversity of device properties (hence a huge increase in possible ‘user agents’) which has led to some devices being incorrectly identified or requiring computationally expensive additional processing (for example, by the use of additional ‘regexes’ or regular expressions) to be correctly identified. Furthermore, as the capabilities of successive generations of devices have increased, so have the complexities of the associated identifiers. In some circumstances, devices may make use of multiple, different identifiers at different times and according to the circumstance. Yet further, there is a need not only to identify communications devices but also other clients, such as automated software applications (‘bots’) which access web resources (for uses such as web crawling)—where such bots are generally thought to contribute to more than half of all web traffic.

There is therefore a need for a new approach to determining the properties of a client communicating via a network, such as a communications device.

References to a client, as used herein, may refer to a device, computer or program which sends a request to and/or accesses a resource/service made available by a server (which may or may not be located on another computer), preferably via a computer network connection. It will be appreciated that a client may be formed of computer hardware, computer software, or a combination thereof. Examples of clients include communication devices, software libraries used within applications, software agents running on servers (e.g. bots), and software applications running on devices. A client may be controlled by an end user (directly or indirectly), or may not be so controlled (i.e. it may operate without user input). A ‘device’, as used herein, is a specific example of a client, and in most instances these terms may be understood to be interchangeable.

References to a client/device property or properties, as used here, may refer to hardware and/or software characteristics of the client/device, wherein the latter (in the case of a device) may comprise characteristics of the operating system or a software application such as a web browser, or another software component, including but not limited to software libraries used within applications, software agents running on servers (e.g. bots), apps on devices etc., As such, references herein to components may be or comprise hardware and/or software components of the client/device. As will be appreciated, such properties may in turn relate to client/device capabilities. A device, as referred to herein, may be a physical device or may be a virtual device, such as an emulated or simulated device.

According to an aspect of the invention there is provided a method of determining the properties of a communications device according to claim 1. The (computer-implemented) method may comprise: receiving an (or at least one) identifier from the communications device; parsing the (or each) identifier into a plurality of tokens; and retrieving in dependence on each token at least one component from a database, the (at least one) component referencing at least one device property; and determining in dependence on the retrieved (at least one) component a set of device properties; wherein the database comprises a tree data structure in which previously identified tokens are mapped to corresponding components. The method may include receiving a plurality of identifiers or a set of identifiers from the device, and parsing each identifier into a plurality of tokens.

According to an aspect of the invention there is provided a method of determining the properties of a client communicating via a network. The (computer-implemented) method may comprise: receiving an (or at least one identifier) from the client; parsing the (or each) identifier into a plurality of tokens; and retrieving in dependence on each token at least one component from a database, the (at least one) component referencing at least one client property; and determining in dependence on the retrieved (at least one) component a set of client properties; wherein the database comprises a tree data structure in which previously identified tokens are mapped to corresponding components. The method may include receiving a plurality of identifiers or a set of identifiers from the client, and parsing each identifier into a plurality of tokens.

A tree data structure is commonly known as a ‘trie’. The terms are used herein interchangeably.

This may allow for a more comprehensive, flexible, efficient, and faster method of identifying device/client properties than existing methods. Furthermore, this may allow for single-pass, order ambivalent determination of properties from an identifier, and also allow for handling of property hierarchy and inheritance. This may also allow for handling of multiple, different identifiers from a device/client.

References to determining properties of a device/client may involve identifying the device/client making contact with a server (i.e. identifying the device/client as being hardware and/or software) and determining its properties. A determined property of a device/client may be device/client identity, preferably wherein said identity relates to the device/client being hardware and/or software.

Preferably, the tree data structure comprises a sequence of nodes representing the previously identified tokens, the final node of each sequence referencing a plurality of candidate components corresponding to each token. The data structure may comprise a single shallow trie built up from individual tokens or chains of tokens with the significant token or sequence of tokens starting from the root of the trie, and which contains the relevant tokens for all components.

Preferably, retrieving a component from the database comprises traversing the tree data structure and matching a token with at least part of a previously identified token. Matching of a token may be subject to a constraint comprising at least one of: i) the position of the token within the identifier; ii) the proximity of the token to a specified other token within the identifier; and iii) a property of the token determined from the identifier.

Matching of a token may be subject to a group constraint comprising a plurality of related constraints.

The plurality or group of related constraints may be referred to as Constraint Groups or Group Constraints.

Preferably, each component is associated with a component type assigned a level within a predefined hierarchy of device/client properties, such that a device/client property of component of a first or parent type is inherited by a component of a second or child type. A component may be one of a plurality of components inheriting a device/client property from a device/client family component. A component may inherit a device/client property from a generic component of the same type.

Preferably, the method further comprises retrieving a plurality of candidate components from the database, comparing the candidate components at each component level, and reducing the plurality of candidate components to candidate set of components comprising one component per component type.

Comparing candidate components at each component level may be dependent on at least one of: i) a weighting factor assigned to each component; ii) the results of constraint-dependent token matching for each component; and iii) the property specificity of each component.

Preferably, the method further comprises determining at least one component related to a token directly from the identifier.

Preferably, the method further comprises for each component type, determining the component with the greatest property specificity of the candidate set of components.

Preferably, the method further comprises assigning a default or stock component for a component type if no component is determined for said component type.

Preferably, the method further comprises replacing a generic component with a version-specific component.

Preferably, the method further comprises matching a sequence of tokens with one or more previously identified tokens.

Preferably, the method comprises a single traverse of the tree data structure. In some embodiments, the tree data structure may be traversed multiple times, potentially with a modified match condition(s).

A retrieved component may be associated with and may store data for use with a least one other component.

The identifier may comprise a character string and each token may comprise a character substring, preferably delimited by a characteristic of the character string; more preferably delimited by at least one special character (also referred to herein as a delimiter); yet more preferably at least one pre-defined special character. The at least one pre-defined special character may not form part of a token (because it instead delimits between tokens). Parsing the identifier into a plurality of tokens may be based, at least in part, on one or more characteristics of the identifier; preferably one or more characteristics of the character string forming the identifier; more preferably characters in the identifier; yet more preferably pre-defined special characters in the identifier. Parsing preferably does not comprise the use of regular expressions. A token may comprise a plurality of characters. As used herein, the term ‘special character’ preferably connotes a character that is not an alphanumeric character.

Preferably, the tree data structure is encoded in computer memory as character codepoints.

The database may comprise a plurality of tree data structures, one per component type.

The tree data structure may comprise a compressed binary trie such as a Patricia trie.

The identifier may be received from the device/client in a request for content, such as a user-agent string, a Client Hint model header or a Client Hint platform header. Multiple identifiers, potentially of different types, may be received from the device/client. Preferably, the method further comprises receiving a plurality of identifiers and parsing said identifiers into a plurality of tokens.

The method may further comprise providing content to the device/client in dependence on the determined device/client properties.

According to another aspect of the invention there is provided an apparatus for determining properties of a communication device/client, the apparatus comprising a processor for carrying out the methods described above.

According to a further aspect of the invention there is provided a computer program product having stored thereon a program for carrying out the methods described above.

Further aspects and embodiments of the invention are set out in the appended claims.

The new approach may be described as “token-based device/client property determination” or “token-based detection”, wherein an identifier provided by a device/client is analysed as a collection of delimited tokens.

Rather than seeking to match a ‘user agent’ or other identifier against a database, or pre-defined regular expressions, the identifier is parsed into its component tokens delimited by pre-defined special characters, and one or more significant tokens determined to be present in the identifier are matched against a store of pre-determined tokens arranged in a tree or ‘trie’ data structure, allowing for the identification of corresponding ‘components’, corresponding to sets of properties, further analysis of which in turn allows for the properties of the specific device/client to be determined.

Examples of significant tokens include the device/client model, operating system name, browser name etc.

A token may be defined as a contiguous series of characters, terminated by at least one of a set of predetermined delimiter or special characters, which is associated with a device/client property. The characters are generally Unicode characters, not necessarily limited to alphanumeric characters. The skilled person will appreciate other character coding systems may be used.

Other advantages of the claimed token-detection approach may include:
Fast, memory-efficient detection
Single-pass detection of identifier tokens
Detection of identifier tokens irrespective of order in the identifier
Detection of device/client variants.
Support for device/client property hierarchy, inheritance and device/client families
Support for previously unseen User-Agents for existing devices/clients
Separation of detection logic structure from device/client properties data, allowing for:
   Smaller memory footprint
   Easier lookup with other identifiers, eg. TAC (Type Allocation Code, used to uniquely identify wireless devices)
   Support for different data queries.
No requirement for the use of regexes to analyse the identifier
Predictable data structure with no need for ‘convection’ (a recursive process used to condense tree data structures)
Support for Unicode characters in both User-Agents and properties
Support for dynamic value/property extraction
Use in parallel with—and as gradual replacement for-existing device/client property detection methods

Further advantages will be readily appreciated by the skilled person.

The claimed method is typically performed by a computer program running on a server, initiated by and reporting to a calling application running on the same server. Alternatively, the claimed method and calling application may run on separate servers.

Any reference numerals appearing in the claims are by way of illustration only and shall have no limiting effect on the scope of the claims.

Any apparatus feature as described herein may also be provided as a method feature, and vice versa.

Any feature in one aspect of the invention may be applied to other aspects of the invention, in any appropriate combination. In particular, method aspects may be applied to apparatus aspects, and vice versa. Particular combinations of the various features described and defined in any aspects of the invention can be implemented and/or supplied and/or used independently.

The invention also provides a computer program and a computer program product (and optionally a supporting operating system) comprising software code adapted, when executed on a data processing apparatus, to perform any of the methods described herein, including any or all of their component steps and/or comprises any of the apparatus features described herein. Also provided is a computer readable medium having stored thereon the aforesaid computer program. Also provided is a signal embodying the aforesaid computer program and a method of transmitting such a signal. Furthermore, features implemented in hardware may be implemented in software, and vice versa. Any reference to software and hardware features herein should be construed accordingly.

As used herein, means plus function features may be expressed alternatively in terms of their corresponding structure, such as a suitably programmed processor and associated memory.

The invention extends to methods and/or apparatus substantially as herein described with reference to the accompanying drawings.

Where system elements are shown communicating via a plurality of data ports the skilled person will understand the exact number of data ports is not prescriptive.

The invention will now be described, purely by way of example, with reference to the accompanying drawings, in which:

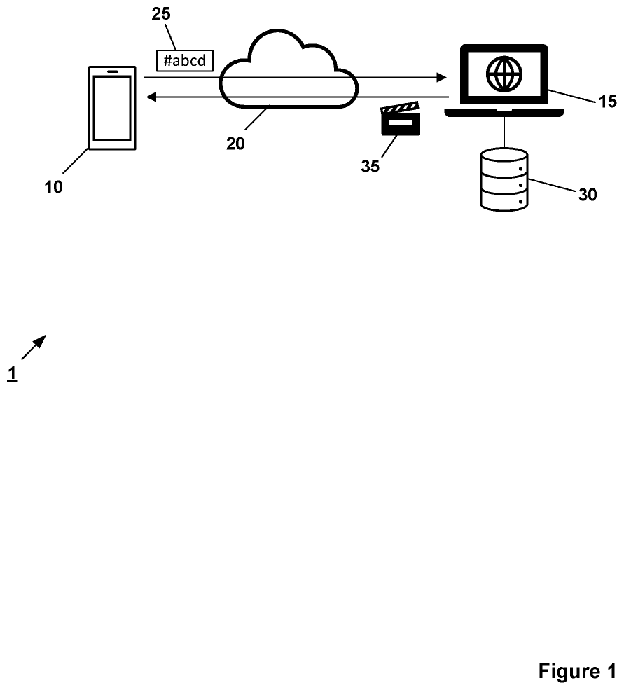

FIG. 1 shows a communications system in overview;

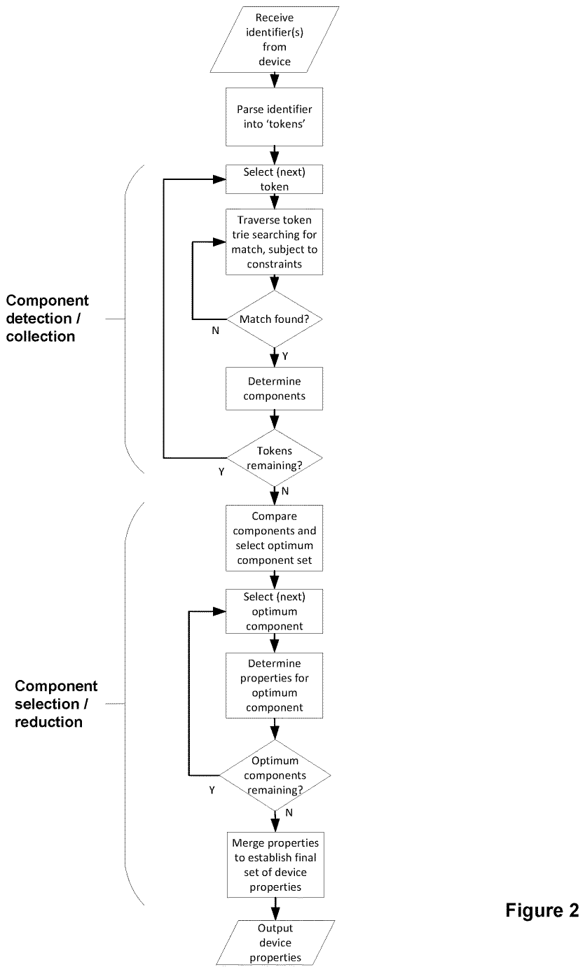

FIG. 2 shows the steps of the device/client properties determination process;

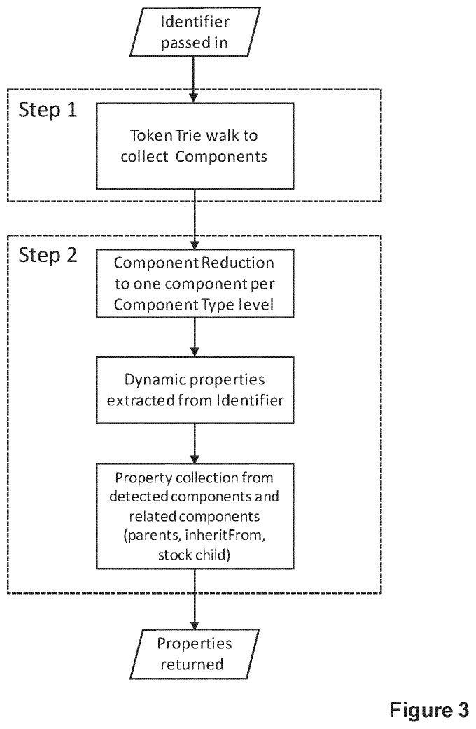

FIG. 3 shows another view of the device/client properties determination process;

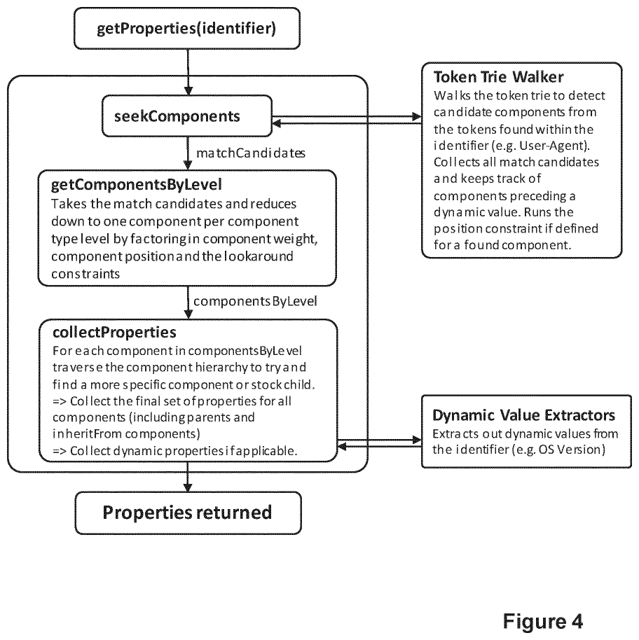

FIG. 4 shows a high-level flow diagram of the device/client properties determination process;

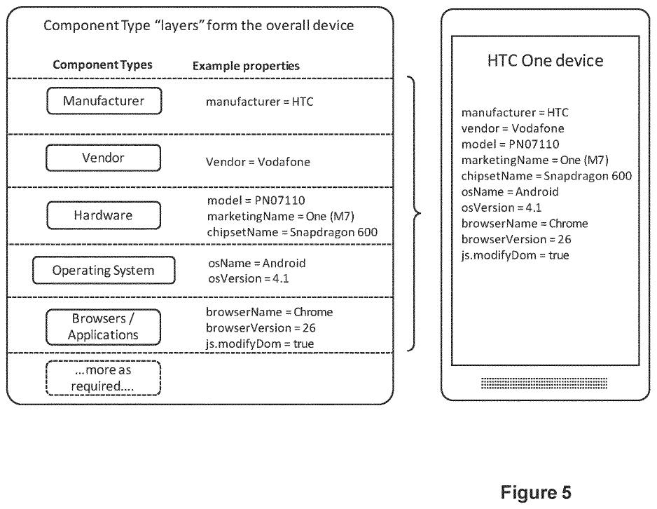

FIG. 5 shows how device/client properties may be defined by a plurality of components arranged in a hierarchy of component types;

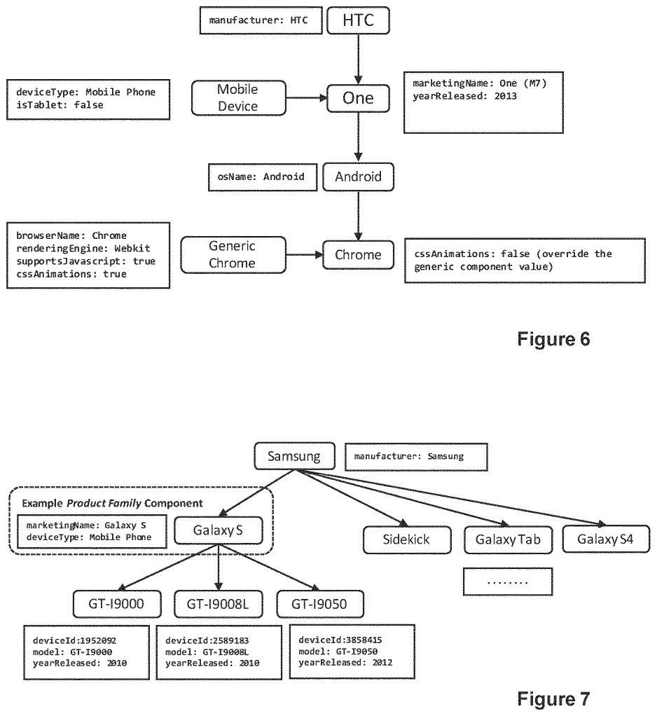

FIG. 6 shows an example of component inheritance;

FIG. 7 shows an example of component inheritance by family;

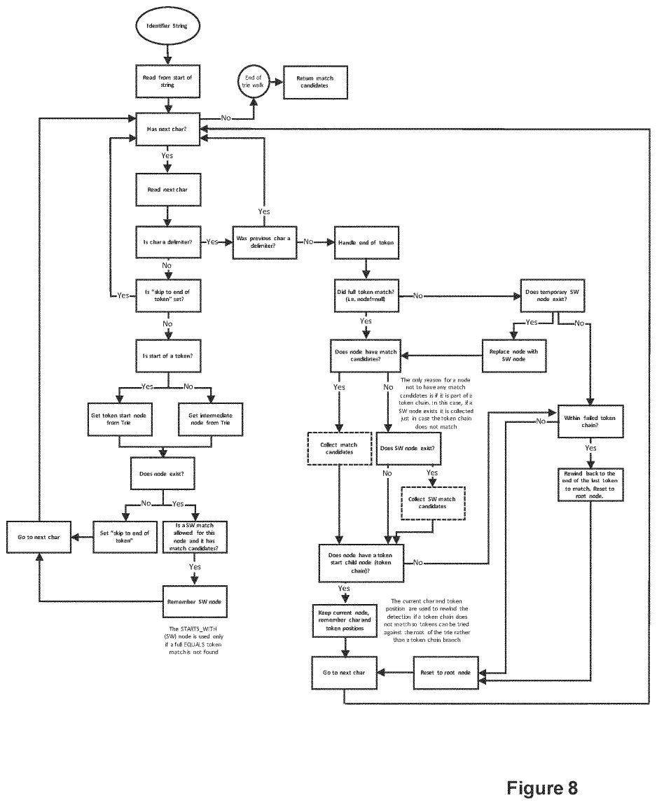

FIG. 8 shows the token trie walking process in more detail;

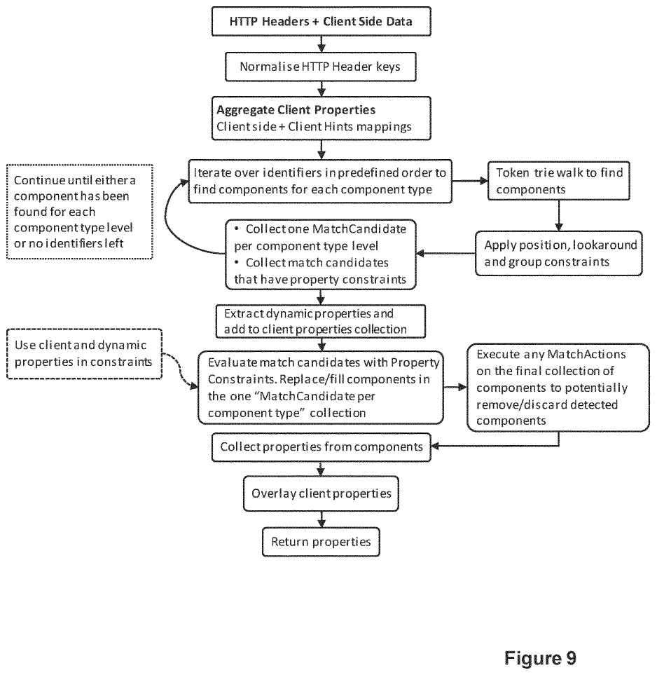

FIG. 9 shows the detection flow modified with property constraints;

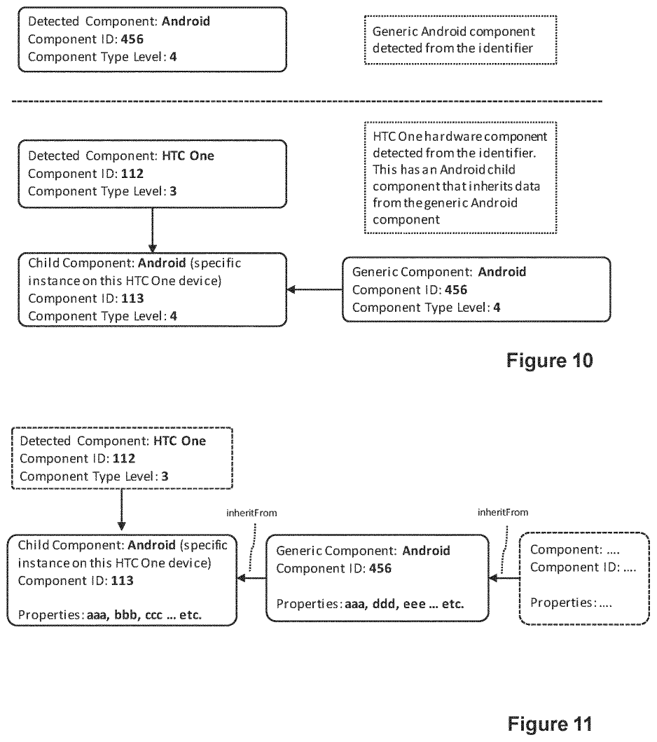

FIG. 10 shows an example of property determination according to component specificity;

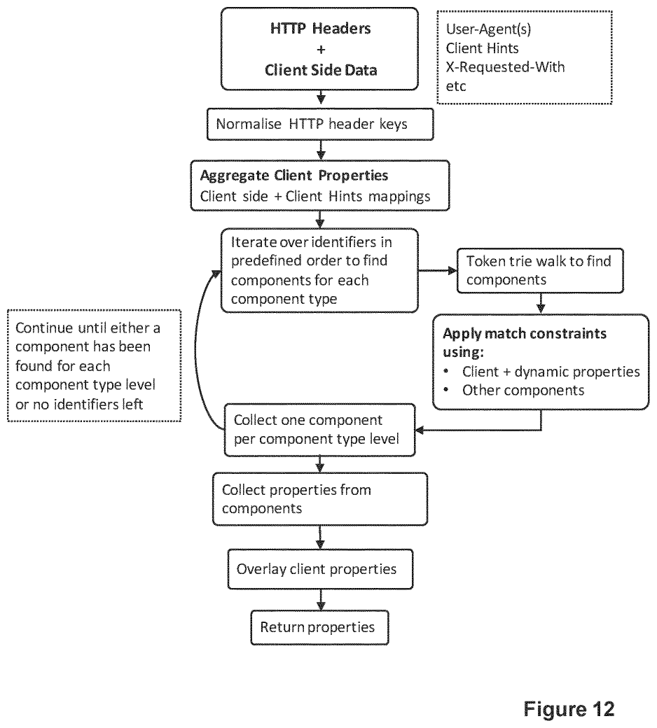

FIG. 11 shows specific property determination in further detail; and

FIG. 12 shows a high-level overview of the handling of multiple inputs.

### OVERVIEW

FIG. 1 shows a communications system in overview, wherein communications device/client 10 interacts with a server 15 over a network 20. When device/client 10 requests content from server 15, it also provides an identifier 25 comprising data, for example in the form of a character string, which allows server 15 to determine certain properties of the device/client 10 and to provided appropriately tailored content 35. Although illustrated as a physical device, the device/client 10 may instead be a virtual device, such as an emulated or simulated device. Alternatively, the client may be software communicating via a network, such as a software library used within an application, a software agent running on servers (i.e. a ‘bot’), or a software application running on a device. The properties of the device/client 10 to be determined may be hardware or software properties.

The determination by server 15 of the properties of device/client 10 involves parsing of the identifier 25 and searching a database 30 comprising known properties of sample devices/clients.

Generally, the device/client properties may be considered as being described by a plurality of data fields or ‘components’, each component relating a property of the device/client (i.e. hardware or software properties). Components are hierarchical, the order determining the inheritance of child components from parent components.

Further device/client properties may be determined by generic components and additional components, which may imply and override certain device/client properties. A weighting factor may be used to prioritise between components of the same type.

For example, the properties of a device/client 10 may be described by a component set: {manufacturer, model, operating system, operating system or OS-version, application, application or app-version}. These properties may be modified by inheritance of generic <browser> application properties, overridden by additional <browser restrictions>, hence the resulting modified component set {manufacturer, model, operating system, OS-version, <browser> application, <browser>-version, <browser restrictions>}.

The database used by server 15 to determine the device/client properties comprises a digital tree or ‘trie’ data structure which maps tokens to components (or potential components) and replicates the hierarchy of components.

The token-based approach as described may be implemented in a Java API, ie. an Application Programming Interface, written in the Java programming language. The skilled person will readily appreciate the potential for implementations in alternative platforms and languages eg. C, Python, PHP, C#etc. References to the API may be understood as being to the method as claimed.

FIG. 2 shows the steps of the device/client properties determination process.
1) Identifier(s) received from the device/client 10
2) The identifier is parsed into ‘tokens’, delimited by special characters
3) Component detection/collection, comprising for each token, a ‘token trie walk’, wherein the trie data structure is traversed searching for a match, subject to various constraints, to determine whether the token corresponds to one or more candidate components. Optionally, dynamic values may also be extracted.
4) Component selection/reduction, comprising comparison of the found components and selection of an ‘optimum’ set, ie. components are merged, the ones which most likely correspond to the device/client properties ones are kept, others are discarded
5) Properties determination/collection, wherein device/client properties are determined from the outstanding components. These properties are then merged and the final set of properties established.

Subsequently, further operations may be performed taking into account the determined device/client properties.

FIG. 3 shows another view of the device/client properties determination process.
Identifier(s) passed in.
Step 1—analysing tokens from identifier to find associated components
   Token trie walk to collect components
   Optionally, extract dynamic properties, as below
Step 2—processing components to arrive at the final set of properties
   Component Reduction to one component per component type level
   Dynamic properties extracted from Identifier
   Property collection from detected components and related components.
Properties returned

Regarding matching, one approach is to use a “strict” detection rule to match a specific instance of a Component. This uses all tokens up to and including the identifiable token. This works well for identifiers of known patterns but less well for identifiers that have relevant tokens in unexpected locations as is the case with many App User-Agents.

Another approach, outlined below, handles identifiers with the significant tokens at any location in the identifier. Given that it does not involve matching a strict predefined identifier pattern it may not be as accurate in some situations. This is mitigated by additional checks performed after token analysis, discussed below. It also allows detection of multiple component types with a single pass over the provided identifier.

As shown, the process comprises two main steps:
1. Determination of possible candidate components for each token in the identifier.
2. Processing of the collected components to merge and collect properties

FIG. 4 shows a high-level flow diagram of the device/client properties determination process. Major functional components (relating to those outlined above and discussed in further detail below) include:
getProperties(identifier(s))
seekComponents
   Token Trie Walker
      Walks the token trie to detect candidate components from the tokens found within an identifier (eg. user agent). Collects all match candidates and keeps track of components preceding a dynamic value. Runs the position constraint if defined for a found component.
   Output: matchCandidates
getComponentsByLevel
   Input: matchCandidates
   Takes the match candidates and reduces down to one component per component type level by factoring in component weight, component position and the lookaround constraints.
   Optionally, execute dynamic value extractors, as below
   Output: componentsByLevel
collectComponents
   Input: componentsByLevel.
   For each component in componentsByLevel traverse the component hierarchy to try and find a more specific component or stock child
      =>Collect the final set of properties for all components (including parent and inheritFrom components)=
      =>Collect dynamic properties, if applicable
   Dynamic ValueExtractors
      Extracts out dynamic values from the identifier (eg. OS version)
Properties returned

Further details of the process are now presented, including:
Device/client identifiers
Component data model
Token trie data structure
Component detection/collection
Component selection/reduction
Properties determination/collection

### Device/client Identifiers

Device/client properties are determined from identifiers provided by the device/client 10 such as HTTP Headers and Make/Model strings, for example User-Agent and the responses according to the Client Hints model (eg. a Client Hint model header or a Client Hint platform header). A Client Hint model header is a structured header in the format Sec-CH-UA-model which indicates (among other things) the device/client model, and a Client Hint platform header is a structured header in the format Sec-CH-UA-platform which indicates (among other things) details of the operating system, or underlying CPU architecture, as is known in the art.

User-Agents are an example of a device identifier containing multiple identifiable tokens. There are many different formats of user-agent, but although they may differ in format, most present details of one or more key aspects of the originating device such as the device name or app name, often followed by a version number. Examples of user-agents include (with key tokens identified in bold text) include:

| | |
|---|---|
| • | Mozilla/5.0 (Linux; Android 4.2.2; HTC One Build/JDQ39) |
| | AppleWebKit/537.36 (KHTML, like Gecko) Chrome/30.0.1599.92 |
| | Mobile Safari/537.36 |
| • | Amazon.com/16.17.0.100 (Android/7.0/SM-G925T) |
| • | UCWEB/2.0 (MIDP-2.0; U; Adr 6.0.1; id; SM-G532G) U2/1.0.0 |
| | UCBrowser/11.1.1.1091 U2/1.0.0 Mobile |
| • | WhatsApp/2.18.61 i |

An identifier may be considered as comprising one or more distinct tokens separated by delimiter or special characters including but not limited to spaces, commas, slashes, opening brackets, semi colons etc. Example common delimiters are shown in the following table:

Delimiter characters

| | |
|---|---|
| white-space | Any white-space character (ie. |
| | any ascii code <= 32) |
| ; | Semi-colon |
| : | Colon |
| / | Forward slash |
| ( | Open parenthesis |
| ) | Close parenthesis |
| [ | Open square bracket |

Some common characters are preferably not used as delimiters because they may be used by hardware manufacturers and software developers for other purposes, for example as in the following table:

Non-delimiter characters

| | |
|---|---|
| . | Full stop/decimal point. Used in version numbers (e.g. 8.6.1) |
| _{—} | Underscore. Used in iOS version numbers. (e.g. 10_3_3) |
| , | Comma. Used in some model names. (e.g. iPhone7,2) |
| - | Dash. Used in some model names. (e.g. GT-i9505) |

Delimiters are used when creating the token data structure, when parsing the identifier and for the token trie walk.

### Client-Side Libraries

In some embodiments, a software component may be installed and run on the device/client 10 and adapted to provide, potentially having first also determined, particular details regarding the properties or capabilities of the device/client 10. This may be used to augment the server-based property determination API. This may be especially useful in cases where full-precision detection of properties would not be possible eg. because all a range of models send the exact same HTTP headers, despite being entirely different device/client types.

### Component Data Model

According to the component data model a given device/client is considered to comprise multiple ‘components’ which taken together define the properties of the device/client.

A component is a collection of properties related to a specific Component Type. Important Component Types include but are not limited to:
Manufacturer.
Vendor—sometimes the same as the manufacturer
Device/client—specific hardware instance (eg. model, yearReleased etc.)
Hardware—generic descriptor (eg. hardware type, cpu, gpu etc.)
Operating System—eg. name, version etc.
App/Browser—App(s) running on the operating system, including browsers (eg. name, version, JavaScript, HTML etc.)

Further component types include: helper, device, hardware, operating_system, browser, app, webview, robot, and virtual. Additional components may be inserted into the data model as needed. This is discussed below.

FIG. 5 shows how device/client properties may be defined by a plurality of components arranged in a hierarchy of component types.

Component Types are structured in a hierarchy, typically wherein the top-most Component Type is the manufacturer, the bottom-most Component Type an app or browser. The order of Component Types defines the allowed property inheritance of the Components. Each Component defines a set of core properties that directly relate to the Component Type.

A Component inherits properties from higher-order parent Components. For example, an Operating System Component inherits properties from its parent Device/client Component.

A Component may also inherit properties from a generic Component of the same type. For example, a specific Browser Component for a given device/client may inherit properties from its parent Operating System component and may also inherit properties from a generic Browser Component.

FIG. 6 shows an example of component inheritance. As shown, the instance of the Chrome browser is running on an ‘HTC One’ mobile device under the Android operating system. The ‘Chrome’ component inherits properties from its parent Components (HTC, One, Android) and also from a ‘Generic Chrome’ component of the same (browser) type. In the present case, inherency rules allow for a browser property (cssAnimations) set by the generic component (cssAnimations: true) to be overridden (cssAnimations: false).

The final properties for a given Component are therefore a combination of those inherited from parent Components and those from other related Components of the same type.

The following tables show component and component type fields:

Component Fields

| Field | Description |
|---|---|
| id | A unique ID across all components, used for comparison purposes. |
| weight | A weighting, defaults to zero. A component with a higher |
| | weighting has priority over components of the same |
| | component type with lower weightings. |
| componentType | The type of a component |
| properties | The collection of property name and values that gets |
| | collected and returned to the calling application. |
| parent | A parent component to form the parent-child hierarchy (optional) |
| inheritsFrom | A more generic component of the same type to inherit from (optional) |
| stockChild | A stock child component. Usually used for stock operating system and |
| | stock browsers of a device/client. (optional) |
| precedesDynamicValue | Boolean flag to indicate if this component typically |
| | precedes a dynamic value. |
| dynamicPropertyRules | A collection of rules to extract dynamic values from |
| | an identifier, eg. browser version |
| versionSpecificChildren | A collection of child components with a specific version range defined. |
| | If a dynamic version is detected it may be used to select |
| | the best version specific child component |
| startVersion | the start version of a version specific child component |
| endVersion | the end version of a version specific child component |

Component Type Fields

| Field | Description |
|---|---|
| id | A unique ID across all component types |
| weight | A weighting, defaults to zero. A higher weighting |
| | gives priority to component types of the same level. |
| level | Each component type has a level to define the hierarchical order. |
| | For example, a manufacturer might be level 1 and a browser |
| | level 5. |
| | Component Types may exist at the same level if they do not |
| | inherit from each other. For example, browsers and apps and |
| | both are installed directly on an operating system; a |
| | browser is merely a specific app type. |

Some component fields (eg. the ‘id’ component field) may be used for internal database housekeeping purposes and are not explicitly used in the detection process.

Additional components may be inserted into the hierarchy as required. Examples include:
Robot—inserted after/alongside the Browser/App component.
Version—to allow for fine-grained properties. For example, a given browser instance may have many child version components each with their own properties.
Product Family—inserted above the device/client component.

FIG. 7 shows an example of component inheritance by family. As shown, certain specific device/client components inherit properties from a product family component.

In some embodiments, in addition to the Component Types listed above there is a special “helper” component type. This is assigned to Components that do not contain properties and whose only role is to ‘help’ other Components. Such helper components may exist in Lookaround Constraints or in Dynamic Property rules, as described below.

The identification process considers each token (or sequence of tokens, ie. a token chain) to find a Component.

For example, consider a ‘Oneplus 7 Pro’ device running the Chrome browser on the Android operating system which presents the following User-Agent identifier:

Mozilla/5.0 (Linux; Android 9; OnePlus 7 PRO) AppleWebKit/537.36
(KHTML, like Gecko) Chrome/76.0.3795.0 Mobile Safari/537.36

This allows for the following tokens—and hence possible components—to be determined:

| Tokens | Possible Component | Notes |
|---|---|---|
| Mozilla | | |
| 5.0 | | |
| Linux | | |
| Android | Operating System | |
| 9 | | Operating System version |
| OnePlus | Manufacturer | Part of device/client |
| | | token chain |
| 7 | Device/client | Part of device/client |
| | | token chain |
| Pro | Device/client | Part of device/client |
| | | token chain |
| AppleWebKit | | Rendering Engine |
| 537.36 | | Rendering Engine version |
| KHTML | | |
| like | | |
| Gecko | | |
| Chrome | Browser | |
| 76.0.3795.0 | | Browser version |
| Mobile | Hardware | |
| Safari | Browser | |
| 537.36 | | Browser version |

As shown above, a component may be found from a single token (eg. “Chrome”) or from a sequence of tokens (eg. “OnePlus 7 Pro”).

### Token Trie Data Structure

Component data is stored alongside pre-determined tokens arranged in a tree or ‘trie’ data structure.

The token trie data structure is constructed from a prior analysis of device/client identifiers and a mapping of identified tokens to components and hence device/client properties. The resulting trie data structure comprises a single shallow trie built up from individual tokens or chains of tokens with the significant token or sequence of tokens starting from the root of the trie, and which contains the relevant tokens for all components, ie. the trie is composed of the significant token or sequence of tokens required to detect a given component.

In some embodiments, the trie may be a compressed binary trie such as a Patricia trie.

The tokens in the trie are represented by linked Node objects containing child Nodes. The final Node of a token or of a chain of tokens contains an array of possible or candidate matching components or MatchCandidates.

In practice, this array usually only contains a single candidate. That is, the data structure is very shallow and only contains single tokens or sequences of related tokens (eg. Mac OS X). This allows very efficient traversal.

More than one candidate only occurs if there are multiple possible components for the exact same token or chain of tokens. In practice, this is rare. It is more likely to occur when there are many different Component Types.

An example token trie is shown below, based on the following example User-Agents (significant tokens are marked in bold text):

Mozilla/5.0 (Linux; Android 4.2.2; HTC One Build/JDQ39) AppleWebKit/537.36 (KHTML,
like Gecko) Chrome/30.0.1599.92 Mobile Safari/537.36
Amazon.com/16.17.0.100 (Android/7.0/SM-G925T)
UCWEB/2.0 (MIDP-2.0; U; Adr 6.0.1; id; SM-G532G) U2/1.0.0 UCBrowser/11.1.1.1091
U2/1.0.0 Mobile
Mozilla/5.0 (iPhone; CPU iPhone OS 7_0 like Mac OS X) AppleWebKit/537.51.1 (KHTML,
like Gecko) Mobile/11A4449d Twitter for iPhone
WhatsApp 2.18.61 i

A suitable token trie is as follows:

A

| | |
|---|---|
| \- mazon.com | App component |
| \- ndroid | OS component |
| Chrome | Browser component |
| HTC | Manufacturer component, Vendor component |
| iPhone | Device/client component |
| \- OS | OS component |

```
like
  \- Mac
    \- OS
```

| | |
|---|---|
| \- X | Noop component, it starts with Like |
| Mobile | Hardware component |
| One | Device/client component |

S

| | |
|---|---|
| \- afari | Browser component |

\- M-G

| | |
|---|---|
| \- 532G | Device/client component |
| \- 925T | Device/client component |
| Twitter | App component |

UC

| | |
|---|---|
| \- WEB | Browser component |
| \- Browser | Browser component |
| WhatsApp | App component |
| \- i | OS component [context specific] |

Preferably, a single trie is used. This allows for very efficient traversal of identifiers. Typically, it is only necessary to traverse the identifier once to determine all the possible components and no additional string operations (regexes) are required.

In some embodiments, however, a plurality of separate Tries are used, for example one per Component Type.

The data file representation (as characters) of the component properties may be different to the in-memory representation (as corresponding codepoints). In the data file, there is a unique array of property names and a unique array of property values. Indexes to both of these arrays are present in the component definition.

That is, the data file therefore contains a unique array of all the components. Other parts of the data file reference the components by the index of the component in the components array. For example, the matching nodes in the token trie contain match candidates and they reference the relevant component by the index in the component array.

During file loading, property objects are created from the arrays so the in-memory component object has a collection of property-value object references rather than the array indexes.

In other words, during loading of the data file, these indexes are used to load the actual component object so the in-memory representation of the data uses object references rather than the array indexes.

### Component Detection/Collection

As mentioned earlier, the device/client properties determination process comprises two main steps. In step 1, the identifier is analysed to determine every token (or sequence of tokens) and an associated component determined. These components are then processed in step 2 to collect the contained properties. This section discusses step 1.

A single token or a series of tokens from the identifier is used to ‘walk’ down the trie data structure to try and find a match. If a match is found, the final matching node of the trie provides one or more possible match candidates. The match candidates contain a reference to the component object. This is discussed further below.

The same token or set of tokens may match more than one component. In this case, a secondary Component Selection step is used to determine the correct Component to use.

In other words, tokens are identified by iterating over the characters (or more accurately the integer codepoints, as explained below) of the identifier to descend the token trie data structure. The iteration stops when one of the predefined delimiter characters is found. This is considered the end of the token and any match candidates are collected at this point. For the next token, the trie walking starts again at the root of the trie unless the token is part of a chain or series of tokens

In more detail:
The characters of the identifier are traversed or walked left to right.
A delimiter character (space, slash etc) indicates the start or end of a token in the identifier. When the start of a token is found the characters up to the next delimiter are used to traverse the Trie data structure.
If a traversal is successful for a given token one or more Components may be found. Specifically, the traversal for a given token may find one or more Match Candidates. A Match Candidate contains a Component and possibly some constraints (eg. Position Constraint, Lookaround Constraint etc) that must be fulfilled before the associated Component can be used.
This process is repeated for all tokens in the identifier.
Each walk starts from the root of the trie unless a token is part of a multi-part walk, for example “Mac OS X” in which case the sequence of tokens is walked in one go.
The identifier traversal aims to make a single pass over the identifier. This happens for the majority of cases but some backtracking may be required if descending down an unmatched chain of tokens.
The process continues until all characters in the identifier have been traversed. The result of the walk is a collection of Match Candidates containing components and match constraints, if applicable.

The traversal of the identifier occurs on a character-by-character basis. In some implementations the codepoint of each character is used rather than the character itself. This is because the token trie data structure is not built up with characters directly. It is built using the numeric codepoint that are stored in byte arrays for each child node in the trie. This allows for high performance as the incoming character codepoint can lookup a node from the byte arrays directly without any extra work. Multi-byte characters (unicode/emoji etc) are handled by splitting into a chain of bytes to walk the trie in multiple steps.

Evidently, specific implementations will have particular considerations. In Java, given that the internal encoding is UTF-16 each codepoint is two bytes long and range from 0 to 65535. To walk the token trie, the codepoints are converted to one or two bytes depending on their value. Codepoints up to and including 255 are handled by one signed byte (−128 to +127). Values greater than this are handled by two bytes and require two hops in the Trie.

Some Unicode characters (eg. emoji) require more than 2 bytes to be represented. This is handled in UTF-16 using surrogate pairs. These pairs are represented by two characters which are combined when printing to screen. In practice, for the traversal of the identifier they are treated as distinct codepoints and are not combined.

As mentioned, the traversal of the identifier is “delimiter aware”. It treats certain character codepoints (eg. space, semi-colon, forward-slash etc) as delimiters between tokens. The token trie walking operates on individual tokens or chains of tokens as defined by the delimiters. The characters of a provided identifier are iterated over and the following occurs:
Each character's codepoint is checked to see whether or not it is a delimiter.
   If the codepoint is not a delimiter then the codepoint is used to start walking down the Token Trie starting from the Root Node.
   If the codepoint is a delimiter then checks are performed to ensure it signifies the end of a token and the final Node from the Trie walk can be used to find possible Match Candidates. A new trie walk then starts with the next token's characters.

In more detail:

FIG. 8 shows the token trie walking process in more detail. In particular, this shows how the match candidates are collected for a given identifier by walking the token trie data structure with the characters of each token within the identifier.

At the end of a token a check is performed to see if a full EQUALS match was found. This means that the full token from the identifier was matched in the token trie data structure. If an EQUALS match is not found then a STARTS_WITH match may be used instead. STARTS_WITH matches are pre-defined so only occur in controlled situations. If a match is found, then match candidates are collected.

It is also possible for a series of tokens to form another token chain. After walking the token trie with a token the final node may indicate that it has a child token to form a chain of tokens. If this occurs, the next token from the identifier is used to continue walking down the branch of the trie instead of from the root of the trie as normally occurs. If a match is found for all tokens in the token chain then the next token (ie. the one after the last of the chain of tokens) from the identifier starts from the root again. If a match is not found for the token chain then the detection rewinds back to the point in the identifier that the chain started so the next token can be checked from the root rather than from within the token chain.

Match candidates are collected along the way when a token or tokens from the identifier match. Each match candidate may contain a component along with match constraints (eg. position constraint, lookaround constraint etc.). These match candidates are then passed to other classes to choose the best set of components. The properties are then collected from the components and returned to the calling application.

### Walking the Token Trie:

The Token Trie is walked down if the codepoint in question is not a delimiter. The Trie walking always starts from the Root Node for each token unless the Trie has a token chain defined (ie. two or more consecutive tokens).
If a given codepoint exists then a matching child Node is returned from the Trie to be used for the next codepoint. If a child is not found then null is returned.
A matching child Node may contain an array of Match Candidates. If Match Candidates exist, a check is performed to see if any of these allow a starts—with match. If so, the Node is stored in a temporary variable for later use. This temporary Node is used as a fallback should the Trie walk not match the full token.
The Trie walking continues until either a delimiter is reached from the identifier or a child node cannot be found.
If a child is not found and there are still more characters remaining in the identifier's current token then a shortcut “skip to end of token” is taken.

### Handling the End of a Token:

Once a delimiter in the identifier is reached it signifies the end of a token and the Trie walk stops for the current token.
A check is performed to see if a Node exists after the Trie walk. If so, then any MatchCandidates contained in the Node can be considered (see below).
The final Node may also be part of a token chain of Nodes. If this is the case the Trie walking continues down the token chain.

### Evaluation of Match Candidates:

If at the end of a token, a Node is found that contains an array of MatchCandidates then the candidates are iterated over to check the following:
   Is a starts-with match permitted?
   Is a token position constraint defined? If so, does the current token index fall within the defined permitted boundaries?
If the Match Candidate checks pass, then the contained Component is added to the collection of “found” Components.
Alternatively, the found “Match Candidates” are collected, each containing a component and possibly a set of constraints to evaluate before the component can be used.

### Starting the Next Token Walk.

The Trie walk continues with the first character of the next token from the identifier. The walk re-starts from the Root Node unless the final Node from the previous token walk has a token chain child defined (ie. has a tokenStartNode). If such a Node exists then the walk continues down this Node chain. If a match cannot be found from the chain then the traversal backtracks so the walk can re-commence using the Root Node instead.

The search for components ends when all characters from the identifier have been consumed. Any components that were found—or alternatively “Match Candidates” containing components—are passed to the Component Selection step (described below).

### Match Constraints

Generally, all tokens must match before a component is considered found. A token may be matched with a full “equals” match or with a “starts with” match.

However, there are some situations where a given token with an associated component is not valid for the current identifier being detected. This may occur if the same token is present in different identifiers but with different meanings. For example, consider the two identifiers below:

Scale/2018.12.210207 CFNetwork/976 Darwin/18.2.0
Discovery GO/2.10.0 (iPod touch; iOS 9.3.5; Scale/2.00)

The first identifier is for an app called Scale. The second identifier is for an app called Discovery Go that uses a framework called Scale.

To detect the Scale app component, the Scale token must be present in the data set (ie. the token trie) with the Scale app associated with it. If this is the case then the first identifier will be correctly detected but the second would cause a mismatch as the Scale framework token would be misidentified as an app.

For known conflict cases like this, a match constraint may be defined. Two examples of match constraint are “Position Constraint” and “Lookaround Constraints”. Additional constraints may also be provided. Examples of these (Constraint Groups or Group Constraints and Property Constraints) are discussed below.

If a constraint is present and the constraint fails then the detected component is discarded.

### Position Constraints

This constraint ensures that the matched token is within a certain offset from the start of the identifier. Minimum and maximum positions are provided to define the permitted range. These are the token positions and not character positions with the first token position starting at zero.

For example:

Identifier: Scale/2018.12.210207 CFNetwork/976 Darwin/18.2.0

| | ∧ | ∧ | ∧ | ∧ | ∧ | ∧ |
|---|---|---|---|---|---|---|
| Token position: | 0 | 1 | 2 | 3 | 4 | 5 |

To ensure the Scale token is only valid at the start of the identifier a position constraint could be defined as follows:
Position constraint for Scale token:

$$Minimum position = ∅$$

$$Maximum position = ∅$$

If the Scale token is detected at any other position it is invalid and is discarded.

### Lookaround Constraints

A lookaround/proximity constraint ensures that there are other components present within defined offsets from the detected component for a match to be valid. When an identifier is being detected, the components found and their token positions are recorded. Once all the tokens in the identifier have been analysed then any components with a defined lookaround constraint are evaluated to verify there are other valid components present. If not, then the component in question is discarded.

For example, consider the below identifier for Microsoft Word:
Word/16.27.19071500 CFNetwork/978.0.7 Darwin/18.6.0 (x86_64)

This identifier is from Word running on macOS (ie. a desktop Mac). By contrast, the identifier for Word running on iOS is as follows:
Word/16.27.19071500 CFNetwork/978.0.7 Darwin/18.6.0

As can be seen, both are very similar apart from the x86_64 token at the end of the first identifier. The key tokens are Word, CFNetwork and Darwin. The Word token detects the app and either CFNetwork or Darwin could be used to detect the operating system.

Taking CFNetwork as an example, if this is used in the data set (ie. the token trie) and associated with the iOS operating system component, eg.:
Token==CFNetwork then return the ios operating system component.

This will return the iOS component when CFNetwork is found in the identifier. This is correct for the second identifier but incorrect for the first identifier. To work around this, a lookaround constraint is added to also consider the presence of the x86_64 token.

A lookaround constraint defines one or more components that must be present within a defined offset from the reference component (CFNetwork in the above case). The constraint defines the component to find and also the allowed offset range from the original reference component. The offsets are positive for a “lookahead” and negative for a “lookbehind”, taking the reference component as position zero. The offsets are shown below for the example identifier:

Identifier: Word/16.27.19071500 CFNetwork/978.0.7 Darwin/18.6.0 (x86_64)

| | ∧ | ∧ | ∧ | ∧ | ∧ | ∧ | ∧ |
|---|---|---|---|---|---|---|---|
| Offsets: | −2 | −1 | 0 | 1 | 2 | 3 | 4 |

(offsets are measured from the reference component “CFNetwork”)

For the correct detection of the operating system the following lookaround constraint may be defined:

```
Lookaround constraint for CFNetwork token:
  Match x86_{—}64 token with offset of
    Minimum offset = 4
    Maximum offset = 4
```

The above constraint ensures that the component found via the CFNetwork token is only valid if the component found via the x86_64 token is also present within the defined offset. If it is not then the CFNetwork component is discarded.

In the example, the component found via the x86_64 token does not fit the regular Component Types. A special “helper” component type is associated with such components and their only role is to help other components. They do not contain any properties. Regular components can also be used in lookaround constraints.

### Group Constraints

A Constraint Group is a collection of Match Constraints. Typically, these are collections of lookaround constraints, although collections of other constraints are possible.

The token approach works by matching one or more tokens from an identifier. This approach works for many devices/clients but if the significant token for a given device/client is short or is a common word then a lookaround constraint may be required to avoid a false positive mis-detection. A As described above, the lookaround constraint checks for the presence of another detected component at a predefined offset to the main component.

The lookaround constraints may be manually or automatically applied based on predefined conditions. The defined constraints will only work for the identifiers that are already mapped to a component. However, there are many variations of User-Agents, especially from apps that are not mapped to every device/client. In these cases, a regular lookaround constraint may prevent a match occurring.

Examples of User-Agent variations (with model in bold) include:

Mozilla/5.0 (Linux; U; Android 4.0.2; en-us; Hero Build/ICL53F)
AppleWebKit/534.30 (KHTML, like Gecko) Version/4.0 Mobile Safari/534.30
UCWEB/2.0 (MIDP-2.0; U; Adr 6.0.1; en-US; Hero) U2/1.0.0
UCBrowser/11.1.3.1128 U2/1.0.0 Mobile
Dalvik/1.6.0 (Linux; U; Android 4.2.2; Hero Build/15.2.A.2.5)
fr.francetv.pluzz/9.6.1 (Linux; An 6.2; Hero Build/M1AJQ)
ExoPlayerLib/2.11.1 FtvPlayerLib/5.13.4
fuboTV/2.0.2 (Linux; Android 6.0.1; Hero Build/LVY48F) FuboPlayer/1.0.2.4
nApps ( Android 6.0.1; Hero; WEBTOON; 3.4.9) glad/1.3.1

For the above User-Agents, the model token is Hero and if used in a rule such as EQUALS (Hero) will result in a “Hero” device/client detection. It is possible for the Hero token to appear in different contexts resulting in a misdetection like in the below example User-Agent.
YMobile/1.0 (asia.olx/; iOs/14_7_1; Apple; 3.5; Hero;)

In this case, the Hero token should not return the “Hero” device/client as it is an app name. To avoid such mis-detections lookaround constraints are added to the Hero device/client detection rules. For example, for first set of User-Agents:

EQUALS(Hero) with lookaround constraint of EQUALS(Android) @ offset:−2,−3
EQUALS(Hero) with lookaround constraint of EQUALS(Adr) @ offset:−3,−3
EQUALS(Hero) with lookaround constraint of EQUALS(An) @ offset:−2,−2 AND
EQUALS(Build) @ offset:1,1

This approach works well if all User-Agent variations are mapped to every device/client. This is not feasible and would be very difficult to manage. To solve this, the concept of Constraint Groups has been created. A Constraint Group avoids needing to map all variations of the User-Agents to each device/client component. Instead, the various constraints are defined separately to the component but referenced by the rules in each applicable component:

Group name: Android Devices
Group ID: 123
Match Constraint 1: Lookaround(EQUALS(Android) @ offset:−2,−3)
Match Constraint 2: Lookaround(EQUALS(Adr) @ offset:−3,−3)
Match Constraint 3: Lookaround(EQUALS(An) @ offset:−2,−2)
AND Lookaround(EQUALS(Build) @ offset:1,1)

When a constraint group is referenced from a detection rule the rule will only pass if one of the Constraint Group match constraints pass.

For example, within a component, the rules for an identifier may comprise Position Constraints and Lookaround Constraints. The Constraint Group is therefore an additional constraint type resulting in the following constraint types available to a component's detection rules:
Position Constraint.
Lookaround Constraint
Constraint Group

A detection rule may have none, some or all constraint types defined. All defined constraints within a rule must pass for a match to be valid with the exception of a Constraint Group where any of the contained constraints must pass.

Position Constraint AND
Lookaround Constraint AND
ConstraintGroup{MatchConstraint1 OR MatchConstraint2 OR ...}

For example, a “Hero” device/client component with a single standard User-Agent mapped to it:

Mozilla/5.0 (Linux; U; Android 4.0.2; en-us; Hero Build/ICL53F)
AppleWebKit/534.30 (KHTML, like Gecko) Version/4.0 Mobile
Safari/534.30

If a lookaround constraint is required, then it may prevent detection of other User-Agent variations. To avoid this, and also to avoid needing to map all User-Agent variations to the device/client, a Constraint Group is used in the detection rule:
EQUALS (Hero) with Constraint Group (id:123)

When the Hero token is detected from a User-Agent the constraints in the Constraint Group are evaluated to see if any of them match. If so, the detection passes and the properties for “Hero” device/client component are used.

If necessary, there may also be additional device/client specific constraints:

```
EQUALS(Hero) with Position Constraint @ 8,8
  AND Lookaround Constraint(EQUALS(Build) @ offset:1,1)
  AND Constraint Group (id:123)
```

### Property Constraints

These are constraints that factor in the dynamically collected values such as version numbers and client-side data. Whereas the main trie walking is left-to-right and only handles EQUALS or STARTS_WITH matches, Property Constraints allow the handling of tokens with significant information in the middle or at the end of the token.

Dynamic property constraints complement component rules to help refine a component match. The constraints described above operate on the tokens found within an identifier. Their primary purpose is to ensure that the given token is valid with respect to the other tokens around it. The Dynamic Property Constraint type moves beyond this to consider the dynamic properties collected from client-side data, Client Hints and User-Agents. It may also be used, for example, for detecting Apple devices using client-side data rules.

The device/client identification approach relies on a significant token from a User-Agent or Client Hint model being detected by the API. There are, however, some cases where a significant token is found in multiple identifiers preventing accurate resolution of the device/client. In such cases, it may be necessary to utilise other signals such as client properties or dynamic properties extracted from a User-Agent to determine the correct device/client.

Example cases needing property constraints include:

### Example 1: Two User-Agents Using the Same X6000 Model

Mozilla/5.0 (Linux; Android 6.0; X6000 Build/MRA58K; wv)
AppleWebKit/537.36 (KHTML, like Gecko) Version/4.0 Chrome/66.0.3359.158
Mobile Safari/537.36
Mozilla/5.0 (Linux; Android 8.1.0; X6000 Build/OPM2.171019.012; wv)
AppleWebKit/537.36 (KHTML, like Gecko) Version/4.0 Chrome/68.0.3440.91
Mobile Safari/537.36

The typical rule, EQUALS(X6000), used to detect these User-Agents cannot distinguish between them. A possible solution is to add a lookaround constraint to check for the presence of either the 6.0 token or the 8.1.0 token. This will work to differentiate these specific User-Agents but it will not work for User-Agents with different version numbers. A better solution is to extract out the version number and use a property constraint to check if it falls within a certain range for each device/client. A possible example is as follows:

Device/client 1: EQUALS (X6000) AND osVersion>=6.0 AND
osVersion<8.0
Device/client 2: EQUALS (X6000) AND osVersion>=8.0 AND
osVersion<9.0

### Example 2: iPhone Detection

The stock User-Agents sent from iOS devices do not contain any tokens that identify the model of the device. One approach to this is to use additional data collected from the client-side library. This works well but it is specific to only client-side data and does not consider dynamic properties from the User-Agent or Client Hint header data. The property constraints described here are similar but the logic to execute the property comparisons works a little differently as will be described later. Possible examples:

```
iPhone 13: EQUALS(iPhone) AND rendererRef=7896 AND
  devicePixelRatio=3
iPhone 12: EQUALS(iPhone) AND rendererRef=1234 AND
audioRef=8974889
iPhone 11: EQUALS(iPhone) AND rendererRef=5827 AND
    widthHeight=375/812
iPhone 10: ...
etc
```

Here, rendererRef and audioRef are fingerprints of the underlying software and hardware which can be used to identify a particular bundle of hardware and software. rendererRef is a graphics fingerprint and audioRef is an audio fingerprint.

### Example 3: Puffin Browser

The Puffin browser sends a desktop User-Agent like the examples below. These User-Agents contain the Puffin browser token and a version number ending in a two-character code indicating the OS and device/client type. IP=iPhone, IT=iPad, AP=Android Phone, AT=Android Tablet, WD=Windows Desktop etc.

Mozilla/5.0 (X11; U; Linux x86_64; ja-JP) AppleWebKit/537.36
(KHTML, like Gecko)
Chrome/30.0.1599.114 Safari/537.36 Puffin/4.0.4IP
Mozilla/5.0 (X11; U; Linux x86_64; en-AU) AppleWebKit/534.35
(KHTML, like Gecko)
Chrome/11.0.696.65 Safari/534.35 Puffin/3.9174IT
Mozilla/5.0 (X11; U; Linux x86_64) AppleWebKit/537.36
(KHTML, like Gecko)
Chrome/30.0.1599.114 Safari/537.36 Puffin/4.1.3.1266AP

A lookaround constraint could be added to detect each of these examples but this would only identify these specific User-Agents. If the version number changes the detection no longer works. A better solution is to use a property constraint with an “ends with” comparator.

iPhone: EQUALS(Puffin) AND browserVersion ENDS_WITH(IP)
iPad: EQUALS(Puffin) AND browserVersion ENDS_WITH(IT)
Android Phone: EQUALS(Puffin) AND browserVersion
ENDS_WITH(AP)

The token trie walk returns Match Candidates. Each match candidate contains a Component and possibly a set of constraints that need to pass before the component can be used.

Therefore, in some embodiments, collections of property constraints are introduced. Each collection contains one or more properties to compare. All property comparisons within a given collection must pass.

There may be more than one collection of property constraints defined. If this is the case then at least one collection must pass for the overall constraint to pass.

In most cases, a given Match Candidate will only have a single collection of property constraints defined. It is, however, possible for additional collections of constraints to be defined to allow for the possibility of handling constraints from different sources that all might be valid. As noted above, at least one collection of constraints must pass for the Match Candidate to be used.

There are some situations where some additional actions must be performed when a component from a Match Candidate is selected as the final component for a given component type.

Some User-Agents masquerade their operating system. This most commonly occurs for mobile devices that pretend to be desktop operating systems. This currently occurs for iPads that claim to be desktop macOS and some older HTC devices.
eg. iPad pretending to be desktop macOS:
Mozilla/5.0 (Macintosh; Intel Mac OS X 10_15) AppleWebKit/605.1.15 (KHTML, like Gecko) Version/13.0 Safari/605.1.15
eg. HTC P715a pretending to run on macOS:
Mozilla/5.0 (Macintosh; U; Intel Mac OS X 10_6_3; HTC-P715a; en-ca)
AppleWebKit/533.16 (KHTML, like Gecko) Version/5.0 Safari/533.16

Both of these examples claim to be desktop macOS but are really mobile devices. The correct iPad is identifiable using client-side properties and the HTC device is identifiable using the significant model tokens in the User-Agent.

The token/component approach attempts to find a component per component type from the available identifiers (eg. one device/client component, one OS component, one browser component etc.). In some situations, like the above examples it is known that a detected component (eg. operating system) is invalid for the device/client. For these cases, it is necessary to replace or remove the detected component and instead rely on either a provided replacement component or the stock component for that device/client. An example of this is shown below:

Using the iPad macOS User-Agent the following components are found via the token trie walk:

| Component Type | Component |
|---|---|
| Device/client | None |
| Operating System | macOS |
| Browser | Safari |

When the client property constraints are evaluated using the client-side data. It is discovered that the underlying device/client is actually a 9th Gen iPad with the following components:

| Component Type | Component |
|---|---|
| Device/client | Apple iPad (9th Gen) |
| Stock Operating System | iPad OS |
| Stock Browser | Safari |

In this case, the operating system detected via the User-Agent tokens is invalid and should not be used. The Match Candidate that contains the Apple iPad (9th Gen) component may define a set of components that should be removed so the stock component can be used instead. In this case, the detected “operating system” component needs to be removed as it is incorrect.

Another example, an iPad that has a stock component of iOS but is upgradeable to iPadOS. In this case, the detected macOS desktop component needs to be replaced with the iPadOS component.

Therefore, in some embodiments some modifications are introduced to the component collection to also handle property constraints:
The client-side properties and Client Hints are collected as normal.
The token trie walk is performed as normal and a collection of Match Candidates is returned.
The Match Candidates are iterated over and any lookaround/group constraints are evaluated to include/exclude each Match Candidate. If the lookaround/group constraints pass then the following occurs:
   If the Match Candidate does not contain a Property Constraint it is added to the “match candidate per component type level” collection provided it does not have a higher weight than an existing component.
   If the Match Candidate does contain a Property Constraint it is added to a separate collection for evaluation later on.
Once all Match Candidates have been evaluated, the set of components in the “match candidate per component type level” collection are iterated over to find any dynamic property rules and the dynamic values are extracted from the identifiers.
Any Match Candidates with Property Constraints collected earlier are iterated over in reverse order as match candidates are ordered by the data file generator least->most desirable and this process stops early if a match is found.
   The properties collected from client-side, Client Hints and dynamically extracted from the identifier are used as inputs to the Property Constraints.
   Each property constraint may define the sources that should be present for the constraint to be evaluated. If defined and an expected source is missing then constraint does not pass
   If all property constraints for a given Match Candidate property constraint collection pass then it is added to the “match candidates per component type level” collection. No further Match Candidates are evaluated.
The final set of “match candidates per component type level” are iterated over to execute any “actions” that are defined such as removing detected components of a certain type.
The “match candidates per component type level” collection is passed to the Property Collector as normal.

FIG. 9 shows the detection flow modified with property constraints.

One advantage is that each component has everything required to detect it defined at the same place. For example, to detect an iPhone 13 mini device. The iPhone 13 mini device component would have a generic iPhone User-Agent mapped to it. This User-Agent would then have a Property Constraint defined along with the regular detection rule. It then becomes clear what is required to detect the component.

Example “iPhone 13 Mini” Device/Client Component

### User-Agents Mapped to Component:

Mozilla/5.0 (iPhone14,4; U; CPU iPhone OS 15_0 like Mac
OS X)
AppleWebKit/602.1.50 (KHTML, like Gecko) Version/10.0 Mobile/
19A346 Safari/602.1
Mozilla/5.0 (iPhone; CPU iPhone OS 15_6 like Mac OS X)
AppleWebKit/605.1.15 (KHTML, like Gecko) FxiOS/103.0 Mobile/
15E148 Safari/605.1.15

Property Constraint:

| Property | Value | Compare As |
|---|---|---|
| screenWidthHeight | 375/812 | string |
| rendererRef | 11985188036 | string |

```
Detection rules without constraint:
  EQUALS(iPhone14,4)
  EQUALS(iPhone) (this is a poor rule and will mismatch)
Detection rules with constraint:
  EQUALS(iPhone14,4)
    (this rule does not need a property constraint)
  EQUALS(iPhone) AND screenWidthHeight=375/812
      AND rendererRef=11985188036
```

### Match Candidates

In practice, the component detection step outlined at the start of the above section does not directly return a component. Instead, the component is wrapped in a Match Candidate that contains both the component and also any match constraints. There may be multiple Match Candidates for the same token to allow for the same token to mean different things depending on its component type, weight and match constraints.

An example of this can be seen with the identifiers from the lookaround constraint where the CFNetwork token is detected and there need to be two match candidates: one for iOS with no lookaround constraint and one for macOS with lookaround constraint.

CFNetwork token detected, two possible match candidates found:
Match Candidate 1: iOS Component (no constraints)
Match Candidate 2: macOS Component (with lookaround constraints)

Both match candidates are evaluated to find the one that is most accurate. If the lookaround constraint is valid then the component with the higher weight takes priority. If the lookaround constraint is invalid then the associated component is discarded.

The MatchCandidate must pass certain checks before the contained Component is added to the “found” component collection. For example:
1. If the Token walk did not traverse the full incoming token from the identifier, a check is performed to verify that a partial starts-with match is allowed by using the swAllowed field.
2. Some tokens, especially short or generic terms, may be incorrectly matched against. To help guard against this, a Match Constraint may be defined. The Match Constraint may contain a Position Constraint, a Lookaround Constraint and/or a Constraint Group. The component within the Match Candidate is only valid if all of the constraints pass.

### Component Selection/Reduction

As mentioned above, once the identifier has been analysed to determine every token (or sequence of tokens) and an associated component determined, these components are then processed in step 2 to collect the contained properties. This section discusses step 2.

After all the tokens from the identifier have been iterated over the result is a collection of match candidates. These match candidates comprise a component and possibly some match constraints. This collection is itself iterated over to try and find one component per component type (ie. one device/client component, one operating system component etc). The match constraints and component weights are used to include/exclude components from the final set.

The aim of this step is to refine the components from step 1 into a set that will be used to collect the final set of device/client properties. Some components may be discarded and others used to find dynamic properties. The process involves:
1. Reduction of/assigning components to one component per component type level
2. Extraction of dynamic properties (Dynamic Value Extraction)
3. Collection of properties from components (and from related Components: parents, inheritsFrom, stockChild)

### 1. Reduction of Components to One Component Per Component Type Level

Firstly, the collection of found components is iterated over to allocate one component per component type level. Lookaround, Group and Property Constraints are also run at this stage if they are present.

If two components in the collection are of the same type or of the same level then the component with the greater weight is chosen. If both are of the same weight then the component found deeper in the identifier is chosen. The aim is to have one component per component type level.

Components may be excluded from the final set due to:
Failing a match constraint.
Losing out to a component of the same type or level with a higher weight.
Losing out to a component of the same type or level with the same weight but found deeper in an identifier.

In some embodiments, a further refinement considers all the children for a parent component to see if the found component fits the data structure. For example, if it is known that a given operating system has certain child browser components then the detected browser component is checked to ensure that it is allowed as a child of the Operating System component.

For example, with key component weights as follows:

| Component Type | | | Component |
|---|---|---|---|
| Level | Component Type | Component | Weight |
| 1 | Manufacturer | Oneplus | 0 |
| 2 | Hardware | Mobile | 0 |
| 3 | Device/client | 7 Pro | 1 |
| 4 | Operating System | Android | 0 |
| 5 | Browser | Chrome | 1 |
| 5 | Browser | Safari | 0 |

the resulting components per level are:

| Component Type | | | Component |
|---|---|---|---|
| Level | Component Type | Component | Weight |
| 1 | Manufacturer | Oneplus | 0 |
| 2 | Vendor | empty | n/a |
| 3 | Device/client | 7 Pro | 1 |
| 4 | Operating System | Android | 0 |
| 5 | Browser | Chrome | 1 |

As mentioned above, Components may also be excluded due to match constraints.

### Extraction of Dynamic Properties

Dynamic properties are generally properties (such as version numbers) which are associated with a token but obtained directly from the user-agent, rather from the tree, eg. a property like a version number extracted from an identifier. Dynamic properties may also be found in Client Hint HTTP headers or collected via JavaScript and passed to the API.

To extract dynamic properties from the identifier the found components are iterated over to check if they contain any associated dynamic property rules. Dynamic property extraction is performed at this stage to avoid unnecessary extraction for components that were excluded in previous steps.

Most dynamic values of interest follow an identifiable token, for example: ‘operating system’ and ‘operating system version’ are a pair; ‘browser’ and ‘browser version’ are another pair:

Mozilla/5.0 (Linux; Android 9; OnePlus 7 PRO) AppleWebKit/537.36
(KHTML, like Gecko) Chrome/76.0.3795.0 Mobile Safari/
537.36

In order to correctly extract the dynamic value from an identifier, a given component has a ‘dynamic value extractor’ or rule defined, ie. a dynamic extraction rule is associated with a property name to which the dynamic value belongs. If such a rule exists it is run against the provided identifier.

In the above example, for the property name ‘browserVersion’ the extracted value of ‘76.0.3795.0’ would be returned.

This approach also allows for cases where there is not an identifiable token immediately before the dynamic value.

Generally, a dynamic extraction rule comprises:
A component that precedes the dynamic value
A value extractor

A component may have multiple dynamic properties. Each individual property may have multiple extraction rules (ordered by priority) associated with it to allow for cases where the dynamic value may follow more than one token (eg. Opera User-Agents, where the browser version may follow either the Opera token or the Version token, see Example 2 below).

During Component detection/collection the tokens in the identifier are iterated over to find associated components. A component has a flag set to ‘true’ to indicate that it may precede a dynamic value. If so, it is collected and stored along with the character position of the matching token for later reference. These collected Components are then referenced by the dynamic extraction rules.

For the case above, the component detection found a Chrome browser. This component may have a dynamic extraction rule defined to find the associated browserVersion property. The rule defines a component that must exist before the dynamic value. If such a component exists then the dynamic value that follows it can be extracted.

In the example, the dynamic extraction rule is referencing the same component as the wrapping parent component. Alternatively, it could reference a different component that precedes the dynamic value, as seen in example 2 below.

### Example 1: Extraction Rule Referencing the Same Component as the Parent from Identifier

Mozilla/5.0 (Linux; Android 9; OnePlus 7 PRO) AppleWebKit/537.36
(KHTML, like Gecko) Chrome/76.0.3795.0 Mobile Safari/537.36

Detected Component: Chrome

```
Properties: ....
Parent Component ....
InheritFrom Component ....
Dynamic Extraction Rule: {
  Property Name: browserVersion
  Component Preceding Dynamic Value: Chrome
  Extractor Type: Version number extraction
}
```

### Example 2: Extraction Rule Referencing a Different Component Preceding the Dynamic Value

Opera/9.80 (J2ME/MIDP; Opera Mini/7.1.32052/29.3530; U; en) Presto/2.8.119 Version/11.10

Detected Component: Opera

```
Properties: ....
Parent Component ....
InheritFrom Component ....
Dynamic Extraction Rule 1: {
  Property Name: browserVersion
  Component Preceding Dynamic Value: Version
  Extractor Type: Version number extraction
}
Dynamic Extraction Rule 2: {
  Property Name: browserVersion
  Component Preceding Dynamic Value: Opera
  Extractor Type: Version number extraction
}
```

The dynamic value may exist after either the Opera token or the Version token if it is present. The extractors are executed in order, breaking on the first match. Some Opera User-Agents do not have the Version token, in this case the first extractor fails and the second one extracts the version after the Opera token.

In the example above, the “Version” Component that is preceding the dynamic value does not fit the regular Component Types. A special “helper” component type is associated with such components and their only role is to help other components. They do not contain any properties.

As mentioned previously, during component detection/collection the character position of the detected component preceding the dynamic value is recorded. If a dynamic extractor rule contains one of these components then the character position along with the full identifier is passed to a dynamic value extractor. For example:

Identifier: Mozilla....(KHTML, like Gecko) Chrome/76.0.3795.0
Mobile ...
Character position at end of token preceding dynamic value is recorded

Three dynamic value extractor types are discussed below; more may be used as necessary. Each dynamic extractor is customised per component instance and takes the starting character position and the full identifier as inputs.
String Extractor—A simple extractor that extracts the dynamic value up to the next delimiter character. Validates the character before the dynamic value (e.g. forward slash, space etc. . . . ). Does not perform any additional validation on the extracted string.
Version Extractor—Extracts all the characters up to the next delimiter character and performs the following validation:
   Validates the character before the dynamic value (e.g. forward slash, space etc. . . . )
   Optionally validates a prefix attached to the version value (eg. ‘v−’ in a version string of ‘v-7.4.2’). The prefix may be included or excluded in the return value.
   Validates the version number itself to ensure it contains digits and a defined separator character. A separator character may be defined as a decimal point (eg. 7.4.2), underscore (eg. 10_1_1) or another character.
   Optionally allows a suffix attached to the version number. The suffix itself is not validated but its presence is (eg. 12.36.2-beta)
   The above validation is performed in a single pass over the version number characters. This custom version extractor is about five times faster than an equivalent regex extractor below and about ten times faster than a pure regex approach.
Regex Extractor
   Runs a regex against the remaining string after the passed character position.
   Since this is a regex, any validation is possible on the dynamic value. The dynamic value does not need to be directly after the preceding token as is the case with the String and Version extractors.
   This may act as a just-in-case extractor with the vast majority of the dynamic values extracted by the Version extractor.
   If a regex extractor is defined it is only run when present in a detected component.

The dynamic value extractors returns the extracted string only if validation passes. Preferably, extractors are only run when present in a detected component and are not run all the time.

### Properties Determination/Collection

The final step is to collect all the properties to return to the calling application. These include the dynamic properties and the properties from each detected component along with properties inherited from generic components, parent components etc.

The final set of components are used to collect the properties to return to the calling application. Each component contains a collection of properties. They may also contain references to other components such as parent components or a more generic form of the component. The final set of properties is the combination of properties loaded from the detected component, the parent components and any generic components.

The components are iterated over in order of their component type level starting from the lowest (ie. Manufacturer level=1) to the highest (eg. browser/app level=5). The aim is to find the best component per level to collect properties from.

Referring to the earlier example, the following components were found in the identifier:

| Component Type | | | Component |
|---|---|---|---|
| Level | Component Type | Component | Weight |
| 1 | Manufacturer | Oneplus | 0 |
| 2 | Vendor | empty | n/a |
| 3 | Device/client | 7 Pro | 1 |
| 4 | Operating System | Android | 0 |
| 5 | Browser | Chrome | 1 |

The property collection starts at level 1 and proceeds level by level until there are no more components to consider.

If a component exists for a given level then a check is performed to see if the component from the previous level contains a more specific child component of the one from the current level. If so, the more specific component is used instead.

FIG. 10 shows an example of property determination according to component specificity, that is, whether, when seeking to determine device/client properties from a component, to use a more specific component of the same type. As shown, a generic ‘Android’ operating system component (ID=456) has been detected from the identifier along with a ‘HTC One’ hardware component (ID=112). A check is performed on the children of the ‘HTC One’ component to see whether it has a child component that inherits data from a matching generic component, in this case from the generic ‘Android’ component with ID=456. If so, the more specific instance (ID=113) is used as it may have device/client specific properties. The specific instance also inherits properties from the generic version.

If a component for a specific level is not found then a check is performed to see if the component from the previous level contains a default stock child for the current level. If so, the default child is used for the current level to fill in the gap. An example of this might be detecting the device/client but not detecting the operating system from the identifier. The default operating system may be used to fill in the gap.

In summary, the component for the current level may be one of:
The original component found via the identifier.
A more specific version of the component (ie. one that inherits from the generic component found)
A version-specific component (eg. Android 13 supports a feature that prior versions did not and thus a version-specific component for Android 13 might have an additional property/value pair set or a different value for a property present in other component)
A default stock component if neither of the above is present.
No component found for this level

If a component is present then the properties for the component are collected. The properties for components of higher levels take priority over those from lower levels (ie. properties in device/client take priority over properties in vendor). There are typically very few properties over-ridden as the properties in a given component usually only relate to the component type of that component.

FIG. 11 shows specific property determination in further detail, using operating system components as an example. If the component has an inheritsFrom relation then properties are also collected from the inheritsFrom component. The inheritsFrom component may also inherit properties from another component. The properties in the more specific instance take priority. The inheritFrom component is typically a more generic version of the component. As shown the properties of the more specific instance (id=113) take priority. The properties from the more generic instance (id=456) are included if they do not already exist in the collection from id=113. The component with ID=456 may also inherit properties from another component.

Given that property collection starts at the lowest component type (ie. manufacturer level=1) and more specific child components are found based on the previous level's component the parent properties are only included in the following situations:
For the first non-null component found, this will be the component found with the lowest component type level.
If a component has a parent of the same component type. This occurs if a component is a more specific child of another component. It may occur if there is a “family” device/client (eg. ‘Galaxy’) with a more specific model device/client (eg. ‘SM-G991U’).

In summary, the properties from each component found per level are collected. A component from a given level may inherit properties from a more generic component and in some situations from a parent component. A default stock child component may be used if there is no component for a given level.

The collected properties are then returned to the calling application.

### Further Refinements

### Handling all Inputs

In some embodiments, the API is adapted to handle all possible inputs sent to it via HTTP headers and ClientSide data in addition to also handling Make/Model identifier lookups. The full collection of HTTP headers includes significantly more data than merely the User-Agent string. It may contain other User-Agent headers (eg. Device-Stock-UA) and also Client Hint headers. The following describes these additional inputs and, at a high-level, a method of handling them.

There are a number of possible inputs to the API:
HTTP Headers
   User-Agent(s), Client Hints, X-Requested-With etc
Client Side JavaScript data
   Regular JS properties+possibly Client Hint data collected from JS
Make/Model
   Only supported by the getProperties (String identifier) method and is not sent in conjunction with any other data.

Possible types of HTTP header for consideration in the API include:

### User-Agents

User-Agent
X-Device-User-Agent
X-Original-User-Agent
X-Operamini-Phone-UA
X-Skyfire-Phone
X-Bolt-Phone-UA
Device-Stock-UA
X-UCbrowser-UA
X-Ucbrowser-Device-UA
X-Ucbrowser-Device
X-Puffin-UA

The User-Agent header may be present on its own or with one or more of the alternative User-Agent headers. Some side loaded browsers and proxies place the original device User-Agent in one of the alternative headers and send a custom value in the regular User-Agent header.

### Client Hints

Sec-CH-UA-Model
Sec-CH-UA.
Sec-CH-UA-Full-Version-List
Sec-CH-UA-Platform.
Sec-CH-UA-Platform-Version

There are additional Client Hint headers that should be returned to the calling application.

### Other

X-Requested-With
   Often contains the package name for Android apps.
From
   Often populated by robot devices/clients

The client side library collects properties via JavaScript. This data also includes a number of Client Hint related properties. The data is returned either in a cookie or via an ajax request and is then passed to the API.

The Client Side data may contain a number of identifiers that also need to be considered when detecting components.

FIG. 12 shows a high-level overview of the handling of multiple inputs. The existing token trie walk is used for all identifiers to find related components. Special handling for identifier strings like “Sec-CH-UA-Full-Version-List” should not be required.

### Step 1: Normalise HTTP Header Keys

The incoming HTTP header keys may be in multiple different forms. They might be in the original form, lowercased, uppercased, prefixed with HTTP_etc. The API normalises them to a standard format for use. This may be done, for example, by lower casing the keys, replacing underscores with dashes and stripping the HTTP_prefix if it exists.

### Step 2: Aggregate Client Properties

The incoming data may contain Client Side JavaScript properties and Client Hint data. The resulting client properties data is the merging of data from these two sources. The client properties data may be used as part of detection constraints and is also the final data added to the properties to be returned so take priority over any static component data.

Client Properties=Client Side JavaScript properties+Client Hint header properties

Client Side JavaScript Properties: All client side JavaScript data is included. The client side JS properties may also contain some Client Hint identifiers such as “ch.browserList”. These are added to the identifier collection along with the HTTP headers for use in the next section.

Client Hint Properties: Client Hint data loaded via HTTP headers is selectively included as it is not desirable to have all HTTP header data returned. The data file contains a mapping of Client Hint field to a property and a possible transformation to convert the Client Hint data to a consistent form for inclusion.

### Step 3: Component Detection Using all Identifiers

The Token & Components approach stores property data in component objects. The component objects are found via a token trie walk using an identifier. In some embodiments, only a single identifier is considered to find components. Alternatively, all identifiers are considered, with multiple trie walks for each different identifier to find the relevant components.

A given identifier may find zero or more components when passed to the token trie. Some identifiers are specific to particular component types. For example, a User-Agent identifier may find components of different types but a Sec-CH-UA-Model identifier should only find a component of the device/client component type.

The data file contains ordered lists of identifiers per component type, according to a pre-determined priority order identifiers per component type. The identifiers for a given component type are iterated over until a component of a matching type is found (and passes the match constraints) or there are no identifiers left to consider. This is repeated for the identifiers associated with each component type. Some identifiers, like User-Agent, may be associated with more than one component type. If such an identifier has already been used to do a trie walk it is not necessary to re-walk the tokens and the previous set of components can be used to find the component of appropriate type.

The goal is to find one component per component type. This set of components is then passed to the existing property collector to aggregate the properties that should be returned to the calling application.

### Match Constraints

When a token is detected via the token trie walk a Match Candidate is returned. A match candidate contains the component and also a number of match constraints. The constraints must pass before the candidate component may be considered for inclusion in the final set of components. The constraints above are specific to the identifier that the component was found from and their main purpose is to ensure the tokens used to find the component are valid.

### Dynamic Properties

The extraction of dynamic data from identifiers remains unchanged except for where it is executed in the API. Currently the dynamic extractors run after the final set of components are found. In order to support property constraints (as above) the dynamic property extraction may need to move to an earlier point in the process so the dynamic properties can be used in the constraints.

Step 4: Collect Properties from Components

The process to collect properties is unchanged except for the moving of dynamic properties extraction to Step 3 above.

### Step 5: Overlay Client Properties and Dynamic Properties

The Client Properties parsed and collected in Step 2 and any extracted dynamic properties from Step 3 take priority over any of the component properties and are added in as a the last step before returning the full set of properties to the calling application.

In some embodiments, certain internal properties are excluded from being returned.

### Component Refinement by Version

The current component detection, as described above, finds components via the token trie walk. The found components are typically the generic form of a component which may also be replaced by device specific stock child if appropriate. There are cases where a version specific component is preferred. Version specific components are important to set the correct properties for a given version or a range of versions. Some examples of this are to set the osName property for Android, Windows and macOS or to set the correct rendering engine for Chrome. One approach to achieve this is by an extension of the component refinement step in the API.

The component definition is extended with a set of optional fields relating to the version range that the component is valid for. If the version range is specified the component must also be a child of another component of the same type.

During the token trie walk a generic “parent” component may be found that has a collection of version-specific child components.

The result of the token trie walk and component detector is a “final” set of components found from the input identifier(s) with at most one per component type level. This collection is passed to the property collection step to collect the properties from each component for returning to the calling application. The current high-level process is as follows:

For each component type level:
Step 1: Refine the component:
   If component is present at a given level:
      Try and find a more specific instance of the component. If none found use the original component at this level
   If no component is present at a given level:
      Try and find a stock child of the previous level component
Step 2: Collect properties
   If a component exists for this component level then:
      Extract any dynamic properties.
      Collect all component properties from self, parent and inheritFrom.

To allow for refinement by version number the following update to the above is made:

For each component type level:
Step 1: Ensure component exists
   If not then select stock component from previous level if applicable
Step 2: Collect dynamic properties
   If the component is present then collect dynamic properties (eg. osVersion)
Step 3: Refine component by version
   If the component is present and has child components of the same type with version ranges then use the collected version property (dynamic property from identifier/client-side/client-hints) to select the best version-specific child component.
Step 4: Refine component as per previous approach
   If component is present at a given level:
      Try and find a more specific instance of the component. If none found use the current component at this level
Step 5: Collect properties
   Collect all component properties from self, parent and inheritFrom.

To refine a component by version as mentioned in “step 3” above a modified binary search is used against the start version of each versioned component. A binary search is more efficient than checking each version of all the child components.

Usually a binary search finds the specific search value from an ordered array but it can be modified so it finds either the specific search value or the closest value that is less than the search term. This is a useful technique to allow for ranges of values.

### The Same Technique can be Used for Version Numbers

Using the modified binary search technique, it is possible to find if a version falls within a range of version numbers. For example, version “5.1” is found between “5.0.6” and “6.0”. This works well if the defined ranges are contiguous, i.e. there are no gaps in the ranges. To handle the case of ranges not being contiguous a secondary version check is required to check the maximum allowed version for a given range.

In the above example, each of the version numbers could be replaced with a version range object. The binary search can still operate against the start versions to find the best version range. Once a version range object is found then the end version can be checked to validate that the search value is actually within the range.

Preferably, the array of versions is ordered and contains unique non-overlapping versions.

In some embodiments, there is only support for numeric version numbers that follow semantic versioning and without supporting version suffixes such as “-beta” (if only populating production release data). If such a suffix exists it is ignored it for the purposes of version comparison.

All version numbers may be padded with zero of more “0.0” as needed for comparison. Versions such as “6”, “6.0”, “6.0.0” are all equivalent.

### Version Ranges

A given component may have an inclusive version range defined with a start version and an optional end version. If the end version is not set then the version range is considered open ended unless a sibling component with higher range is defined, i.e. the effective range runs from the first component's start version up to but not including the second component's start version.

Example osVersions and the Resulting Component
osVersion=4.0.3.
   No version-specific component found, use the parent component
   Properties:
      osName: Android
osVersion=4.2.5698.12.1 (any osVersion >=4.1 and <4.4).
   Use specific “Component 3: Android Jellybean” component
   Properties:
      osName: Android
      os VersionName: Jellybean
osVersion=6.0.1 (any osVersion >=6 and <=6.0.1)
   Use specific “Component 1: Marshmallow” component
   Properties:
      osName: Android
      osVersionName: Marshmallow
osVersion=6.0.2
   No specific component found (outside range of component 1), use parent component.
   Properties:
      osName: Android

### Alternatives & Modifications

The token-based process described above may be used in combination with other device/client property determination processes. For example, properties determined via token-based detection may be added to those already determined via the after the trie walk process described in EP2245836B2 and/or further regexes.

Other refinements to the token-based process include, for example:
Having specific children for all components
Use of the token order to determine potentially useful further information
Stopping detection early for unknown or bogus input strings
Not assuming important information is at the start of a token, ie. for tokens that start with a variable prefix (some may be captured in a rule eg. EQUALS or STARTS_WITH).
Use of token weights (or component weightings as a proxy) to resolve tie-breaker situations.
Taking account of potential misdetections for some very short identifiers, eg. ‘M8’ or ‘One’, to the extent not already handled lookaround constraints automatically included for short and poor tokens when generating the data.
Given that the device/client data is decoupled from the identifier (User-Agent) structure it becomes possible to add the ability to lookup device/client information by Device ID or by TAC. An additional data structure is used to map the Device ID or TAC to the relevant Component. For the Device ID, this may be created on data file load as the relevant Components already have the Device ID as a property. For TAC lookup, the mapped TACs are included in the data set.
Handling “previously unseen” User-Agents for existing devices, for example if they contain a previously known significant token.
Including the ability to query data in different ways, eg. “return all Apple devices” or “return all hardware types”
Use of delimiters of non-ASCII systems (eg. Unicode)
Storing tokens in the token trie ‘backwards’ (ie. starting with the last characters of each token). There are a handful of cases where backwards iteration over a token may be beneficial. The main use case would be if a token contains a variable prefix but a useful suffix (The Puffin browser uses tokens like 10.12.3Ph to capture both the version number and the hardware it is running on).

Although the above description has principally been described with reference to the client being a device (and/or having hardware properties), it will be appreciated that the invention may also be applied to software-based clients, such as ‘bots’. Such bots may be treated in the same way as communication devices by the invention, where bots may return blank results in relation to hardware related components in the token trie walk.

Although strictly speaking the term ‘user-agent’ implies the presence of a (human) user, it will be appreciated that a ‘user-agent’ may also be used in the described invention in respect of clients which operate without a (human) user being directly involved, where a ‘user-agent’ in respect of such bots may be obtained in the same way. Alternatively, a different form of identifier may be used for such clients.

It will be understood that the present invention has been described above purely by way of example, and modifications of detail can be made within the scope of the invention.

Embodiment of the disclosures are described further in the following clauses:
1. A method of determining properties of a communications device, the method comprising:
   receiving an identifier from the communications device;
   parsing the identifier into a plurality of tokens; and
   retrieving in dependence on each token at least one component from a database, the component referencing at least one device property; and
   determining in dependence on the retrieved components a set of device properties;
   wherein the database comprises a tree data structure in which previously identified tokens are mapped to corresponding components.
2. A method according to clause 1, wherein the tree data structure comprises a sequence of nodes representing the previously identified tokens, the final node of each sequence referencing a plurality of candidate components corresponding to each token.
3. A method according to clause 1 or 2, wherein retrieving a component from the database comprises traversing the tree data structure and matching a token with at least part of a previously identified token.
4. A method according to clause 3, wherein matching of a token is subject to a constraint comprising at least one of:
   i) the position of the token within the identifier;
   ii) the proximity of the token to a specified other token within the identifier; and
   iii) a property of the token determined from the identifier.
5. A method according to clause 4, wherein matching of a token is subject to a group constraint comprising a plurality of related constraints.
6. A method according to any preceding clause, wherein each component is associated with a component type assigned a level within a predefined hierarchy of device properties, such that a device property of component of a first or parent type is inherited by a component of a second or child type.
7. A method according to clause 6, wherein a component is one of a plurality of components inheriting a device property from a device family component.
8. A method according to clause 6 or 7, wherein a component inherits a device property from a generic component of the same type.
9. A method according to any of clauses 6 to 8, further comprising retrieving a plurality of candidate components from the database, comparing the candidate components at each component level, and reducing the plurality of candidate components to candidate set of components comprising one component per component type.
10. A method according to clause 9, wherein comparing candidate components at each component level is dependent on at least one of:
   i) a weighting factor assigned to each component;
   ii) the results of constraint-dependent token matching for each component;
   iii) the property specificity of each component.
11. A method according to any preceding clause, further comprising determining at least one component related to a token directly from the identifier.
12. A method according to any of clauses 6 to 11, further comprising for each component type, determining the component with the greatest property specificity of the candidate set of components.
13. A method according to any of clauses 9 to 12, further comprising assigning a default or stock component for a component type if no component is determined for said component type.
14. A method according to any of clauses 9 to 13, further comprising replacing a generic component with a version-specific component.
15. A method according to any preceding clause further comprising matching a sequence of tokens with one or more previously identified tokens.
16. A method according to any of clauses 3 to 15 comprising a single traverse of the tree data structure.
17. A method according to any preceding clause, wherein a retrieved component is associated with and stores data for use with a least one other component.
18. A method according to any previous clause, wherein the identifier comprises a character string and each token comprises a character substring delimited by at least one pre-defined special character.
19. A method according to clause 18 wherein the tree data structure is encoded in computer memory as character codepoints.
20. A method according to any of clauses 6 to 19, wherein the database comprises a plurality of tree data structures, one per component type.
21. A method according to any preceding clause, wherein the tree data structure comprises a compressed binary trie such as a Patricia trie.
22. A method according to any preceding clause, wherein the identifier is received from the device in a request for content.
23. A method according to clause 22, wherein the identifier comprises one or more of: a user-agent string, a Client Hint model header or a Client Hint platform header.
24. A method according to any preceding clause, further comprising receiving a plurality of identifiers and parsing said identifiers into a plurality of tokens.
25. A method according to any preceding clause, further comprising providing content to the device in dependence on the determined device properties.
26. Apparatus for determining properties of a communication device, the apparatus comprising a processor for carrying out the method of any preceding clause.
27. A computer program product having stored thereon a program for carrying out the method of any one of clauses 1 to 25.

1. A method of determining properties of a client communicating via a network, the method comprising:
receiving an identifier from the client;
parsing the identifier into a plurality of tokens; and
retrieving in dependence on each token at least one component from a database, the component referencing at least one client property; and
determining in dependence on the retrieved components a set of client properties;
wherein the database comprises a tree data structure in which previously identified tokens are mapped to corresponding components.

2. A method according to claim 1, wherein the tree data structure comprises a sequence of nodes representing the previously identified tokens, the final node of each sequence referencing a plurality of candidate components corresponding to each token.

3. A method according to claim 1, wherein retrieving a component from the database comprises traversing the tree data structure and matching a token with at least part of a previously identified token.

4. A method according to claim 3, wherein matching of a token is subject to a constraint comprising at least one of:
i) the position of the token within the identifier;
ii) the proximity of the token to a specified other token within the identifier; and
iii) a property of the token determined from the identifier.

5. A method according to claim 4, wherein matching of a token is subject to a group constraint comprising a plurality of related constraints.

6. A method according to claim 1, wherein each component is associated with a component type assigned a level within a predefined hierarchy of client properties, such that a client property of component of a first or parent type is inherited by a component of a second or child type.

7. A method according to claim 6, wherein a component is one of a plurality of components inheriting a client property from a client family component.

8. A method according to claim 6, wherein a component inherits a client property from a generic component of the same type.

9. A method according to claim 6, further comprising retrieving a plurality of candidate components from the database, comparing the candidate components at each component level, and reducing the plurality of candidate components to candidate set of components comprising one component per component type.

10. A method according to claim 9, wherein comparing candidate components at each component level is dependent on at least one of:
i) a weighting factor assigned to each component;
ii) the results of constraint-dependent token matching for each component;
iii) the property specificity of each component.

11. A method according to claim 1, further comprising determining at least one component related to a token directly from the identifier.

12. A method according to claim 6, further comprising for each component type, determining the component with the greatest property specificity of the candidate set of components.

13. A method according to claim 9, further comprising assigning a default or stock component for a component type if no component is determined for said component type.

14. A method according to claim 9, further comprising replacing a generic component with a version-specific component.

15. A method according to claim 1, further comprising matching a sequence of tokens with one or more previously identified tokens.

16. A method according to claim 3, comprising a single traverse of the tree data structure.

17. A method according to claim 1, wherein a retrieved component is associated with and stores data for use with a least one other component.

18. A method according to claim 1, wherein the identifier comprises a character string and each token comprises a character substring delimited by at least one pre-defined special character.

19. (canceled)

20. A method according to claim 6, wherein the database comprises a plurality of tree data structures, one per component type.

21. (canceled)

22. (canceled)

23. (canceled)

24. (canceled)

25. (canceled)

26. Apparatus for determining properties of a client communicating via a network, the apparatus comprising a processor for carrying out the method of claim 1.

27. (canceled)
